(19) United States
(12) Patent Application Publication
(10) Pub. No.: US 2007/0101255 A1
(43) Pub. Date: May 3, 2007

(54) Chart element variations

(75) Inventors: Anupam Garg, Redmond, WA (US); Miltiadis Vafiadis, Redmond, WA (US); Sander Viegers, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/265,376

(22) Filed: Nov. 2, 2005

(51) Int. Cl. G06F 17/00

(52) U.S. Cl. 715/509; 715/517; 715/530

(57) ABSTRACT

Various technologies and techniques are disclosed that enhance the creation of charts. The number of steps it takes to fine-tune a chart can be reduced by providing various element variation layouts that the user can select, such as with a single selection on a toolbar. When the user selects a chart element layout for a given chart, the system performs one or more steps to format the chart with the selected elements. For example, the system removes elements that are not shown in the selected variation but that are currently on the chart. The system adds elements shown in the selected variation that are not currently on the chart. The system selectively leaves elements shown in the variation that are already on the chart unchanged. The system adjusts the location of elements to look like the selected variation.

### BACKGROUND

There are various software programs that allow users to create charts, such as bar charts, pie charts, line charts, or scatter charts. Examples of such software programs that allow users to create charts include spreadsheet programs such as MICROSOFT® Office Excel and Lotus 1-2-3. The user must go through a series of steps to create a chart with a certain style and layout. This process can be very tedious and involve dozens of choices, even for the advanced user. In such programs, the user has to manually add or remove a set of chart elements to communicate their data more effectively. For example, they might need to add data labels to make it easier for people viewing the chart to read the exact value of each data point. Furthermore, a large number of users find it hard to figure out which are the most effective combinations of chart elements they need to have to make their chart most meaningful; they do not want to be in the shoes of a designer. Research shows that effectively communicating data is often more important than the visual appearance.

### SUMMARY

Described herein are various technologies and techniques that enhance the creation of charts. As one non-limiting example, the number of steps it takes to fine-tune a chart can be reduced by providing various element variation layouts that the user can take advantage of, such as with a single selection on a toolbar or menu, or programmatically from another program using automation. These element variation layouts can allow users to create good looking charts that effectively communicate data by selecting between meaningful combinations of chart elements. When the user selects an element variation layout for a given chart, the system performs one or more steps to format the chart with the selected elements. For example, the system removes elements that are not shown in the selected variation but that are currently on the chart. The system adds elements shown in the selected variation that are not currently on the chart. The system selectively leaves elements shown in the variation that are already on the chart unchanged. The system adjusts the positioning of elements to look like the selected variation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one aspect of the present invention.

FIG. 2 is a diagrammatic view of a charting program operating on the computer system of FIG. 1 in one aspect of the present invention.

FIG. 3 is a high-level process flow diagram for one aspect of the system of FIG. 1.

FIG. 4 is a process flow diagram for one aspect of the system of FIG. 1 illustrating the stages involved in applying a selected element variation layout to a chart.

FIG. 5 is a process flow diagram for one aspect of the system of FIG. 1 illustrating the stages involved in updating an existing chart with a selected element variation layout.

FIG. 6 is a process flow diagram for one aspect of the system of FIG. 1 illustrating the stages involved in creating a new chart by selecting an element variation layout.

FIG. 7 is a simulated screen for one aspect of the system of FIG. 1 that illustrates how a user can select an element variation layout from a toolbar.

FIG. 8 is a simulated chart for one aspect of the system of FIG. 1 illustrating an example element variation layout for a column chart.

FIG. 9 is a simulated chart for one aspect of the system of FIG. 1 illustrating an example element variation layout for a line chart.

FIG. 10 is a simulated chart for one aspect of the system of FIG. 1 illustrating an example element variation layout for a column chart.

FIG. 11 is a simulated chart for one aspect of the system of FIG. 1 illustrating an example element variation layout for a scatter chart.

FIG. 12 is a simulated chart for one aspect of the system of FIG. 1 illustrating an example element variation layout for a stacked column chart.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The present invention is directed toward enhancing the creation of charts in one or more aspects of the system, but the present invention also serves other purposes in addition to these. One or more of the techniques described herein can be implemented as features within a spreadsheet software program such as MICROSOFT® Office Excel, Lotus 1-2-3, or from any other type of program or service that allows creation of charts. As described in further detail herein, in one aspect of the system, the number of steps it takes to fine-tune a chart can be reduced by providing various element variation layouts that the user can take advantage of, such as with a single selection on a toolbar or menu, or programmatically from another program, such as using automation. The system then performs one or more steps in order to apply the selected element variation layout to the chart. In one aspect, by providing element variation layouts, users are able to create good looking charts that effectively communicate data by selecting between meaningful combinations of chart elements. In another aspect, by providing element variation layouts, users can help avoid having redundant information in their charts (e.g. a legend and a data table together). In another aspect, by providing element variation layouts, users can learn about and use less commonly known chart elements that could be useful, such as series lines or drop lines.

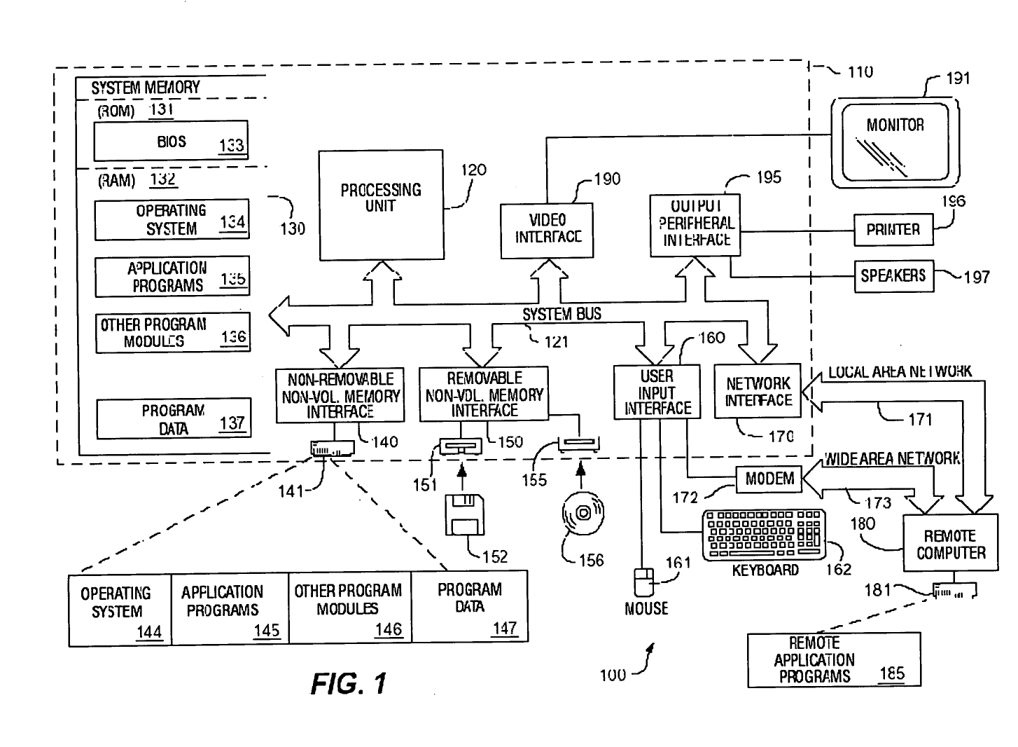

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

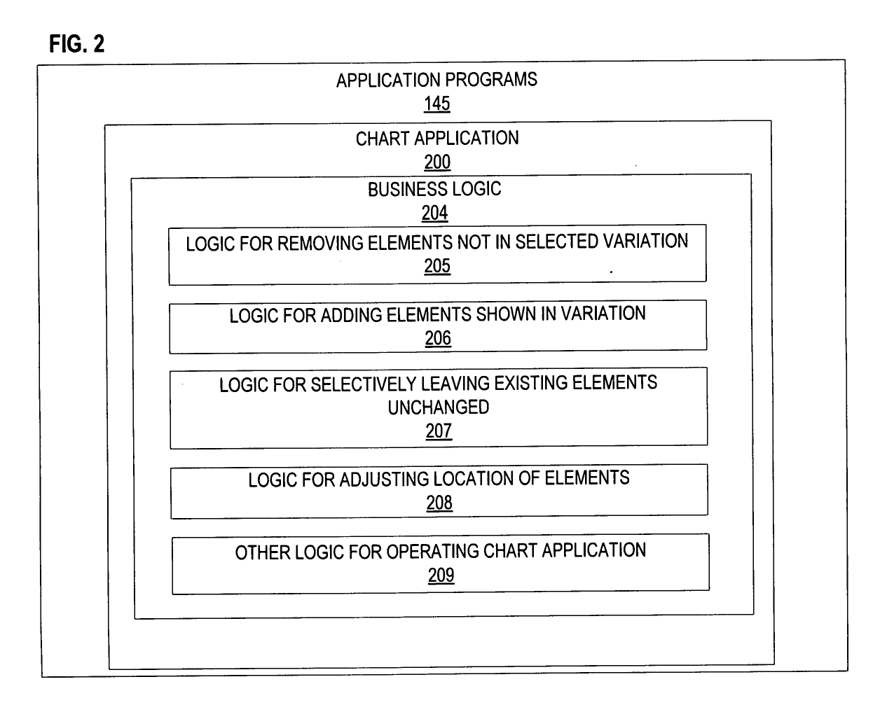

Turning now to FIG. 2 with continued reference to FIG. 1, a charting application 200 operating on computer 110 in one aspect of the present invention is illustrated. In the example illustrated on FIG. 2, charting application 200 is one of application programs 145 that reside on computer 110. Alternatively or additionally, one or more parts of charting application 200 can be part of application programs 135 in RAM 132, on remote computer 181 with remote application programs 185, or other such variations as would occur to one in the computer software art.

Charting application 200 includes business logic 204, which is responsible for carrying out some or all of the techniques described herein. Business logic includes logic for removing elements not in the selected element variation 205, logic for adding elements shown in the selected element variation 206, logic for selectively leaving existing elements unchanged 207, logic for adjusting the location of elements 208, and other logic for operating the charting application 209. In one aspect, business logic 204 is operable to be called programmatically from another program, such as using a single call to a procedure in business logic 204. In FIG. 2, business logic 204 is shown to reside on computer 110 as part of application programs 145. However, it will be understood that business logic 204 can alternatively or additionally be embodied as computer-executable instructions on one or more computers and/or in different variations than shown on FIG. 2. As one non-limiting example, one or more parts of business logic 204 could alternatively or additionally be implemented as an XML web service that resides on an external computer that is called when needed.

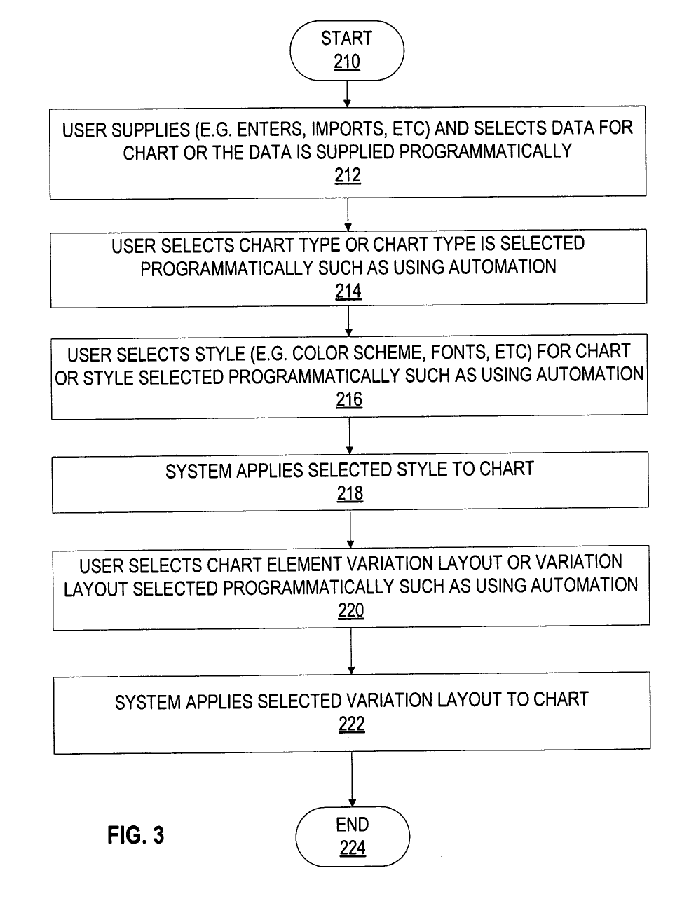

Turning now to FIGS. 3-6 with continued reference to FIGS. 1-2, the stages for implementing one or more aspects of charting application 200 of system 100 are described in further detail. FIG. 3 is a high level process flow diagram of one aspect of the current invention. In one form, the process of FIG. 3 is at least partially implemented in the operating logic of system 100. The process begins at start point 210 with the user supplying (e.g. entering, importing, etc.) and selecting data for the chart, or with the chart data being supplied programmatically (stage 212). The user then selects the type of chart, such as pie, bar, line, etc, or the type is selected programmatically. (stage 214). The user selects the chart style (e.g. color scheme, fonts, etc.), or the chart style is selected programmatically (stage 216). The system applies the selected chart style to the chart (stage 218). The user also selects a particular chart element variation layout, or the element variation layout is selected programmatically (stage 220). The system applies the selected variation layout to the chart (stage 222) using business logic 204. The order of the stages described in FIG. 3 can be followed in a different order and still be within the spirit of the invention. As one non-limiting example, the user could select a particular chart element variation layout (stage 220) before selecting a chart style (stage 216).

As previously mentioned, in one aspect, these selection stages are implemented programmatically. One example of such programmatic implementation includes creating a custom program that includes a charting feature, and then calling business logic 204 to use one or more aspects of the current invention in the custom program. In one variation, the chart element variation layout can be selected (stage 220) and applied (stage 222) programmatically to the chart in the custom program by a single procedure call to business logic 204. Multiple procedure calls could also be used.

In one aspect of the invention, the element variations that are used in the chart element variation layouts described in stages 220 and 222 can include some, all, or additional elements and properties than the following:
Plot Area: On/Off property
Legend: On/Off property, Position property (values: Bottom, Corner, Top, Right, Left)
Chart Title: On/Off property
Data Table: On/Off property
Legend Key: On/Off property
x-axis: On/Off property
x-axis title: On/Off property
y-axis: On/Off property
y-axis title: On/Off property
z-axis: On/Off property
z-axis title: On/Off property
Secondary Axis: On/Off property
Secondary Axis Title: On/Off property
Data Labels: Series it applies to property (first, last, all), On/Off property, Position property (values: depends on the chart type)
Data Markers: On/Off property
Trendline: Series it applies to property (first, last, all), Type property (Linear, Logarithmic, Polynomial, Power, Exponential, Moving Average), Label On/Off property (includes equation and R-squared)
Up/Down Bars: On/Off property
High/Low Lines: On/Off property
X axis Major Gridlines: On/Off property
Y axis Major Gridlines: On/Off property
Z axis Major Gridlines: On/Off property
Secondary Axis Gridlines: On/Off property
Minor axis gridlines: On/Off property
3D Walls: On/Off property
3D Floor: On/Off property

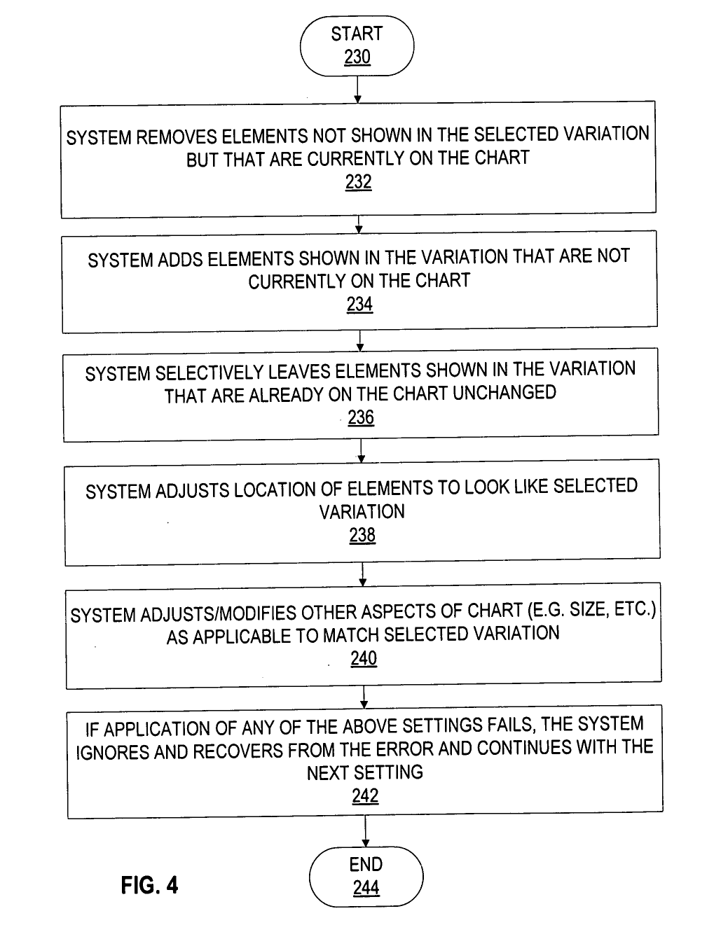

Elements can contain sub-elements and/or properties. In the above example, most of the elements are on/off flags with extra properties (e.g. Data Label Contains) that apply only if the flag is on (e.g. if the flag is off, the code ignores the extra properties). If something was “on” before the user selected the variation and the variation sets it to “on”, it will remain on and the extra properties will be set as specified in the variation. Other formatting properties (such as color) are not affected when the user selects a particular chart element variation layout. For example, if the existing data labels are “on”, they contain Value and Category name, and the text color is red, and then the user applies an element variation that defines data labels as “on” containing just the Value, the resulting data labels will only contain Value and still be red. These stages are described in further detail in the flow diagram discussed in FIG. 4.

In one aspect of the invention, trendlines are a special case, because there can be multiple trendlines for the same series. As one non-limiting example, trendlines can have the following behavior:
If there were no trendlines for a series and the variation setting is “off”, no trendlines are displayed.
If there were no trendlines for a series and the variation setting is “on”, one trendline is added based on the rest of the settings in the variation.
If there were one or more trendlines for a series and the variation setting is “off”, all trendlines are removed.
In one variation, if there were one or more trendlines for a series and the variation setting is “on”, the first trendline is kept and the rest are removed. In another variation, all of the trendlines are kept.

In one aspect of the invention, there are some general rules that are used in defining the chart element variation layouts that are made available for selection by the user or for execution programmatically as described in stage 220:
Vertical gridlines are not typically used for charts with a category axis (horizontal gridlines are not used at all for bar charts)
Data Labels or Data Table are typically used when the exact values are important
Gridlines are typically used when the scale is important
Axes lines and tick marks are not typically used in simple variations
The simple variations for 3D charts do not typically use a floor.
   These general rules are illustrative only, and numerous other rules instead of or in addition to these can be used in defining the element variation layouts that are made available to the user or available programmatically. The process then ends at end point 224.

FIG. 4 illustrates the stages involved in applying a selected element variation layout to a chart. In one form, the process of FIG. 4 is at least partially implemented in the operating logic of system 100. The process begins at start point 230 with charting application 200 executing business logic 205 and removing elements that are not shown in the selected variation but that are currently on the chart (stage 232). Business logic 206 executes and adds elements shown in the variation that are not currently on the chart (234). Business logic 207 executes and selectively leaves elements shown in the variation that are already on the chart unchanged (236). In other words, if the elements are already identical to the selected variation, they are unchanged. If the elements have some aspects (e.g. sub-elements and/or properties) identical to the selected variation but others different, then those aspects that are different are changed to match. Business logic 208 executes and adjusts the positioning of elements to look like the selected chart element variation (stage 238). For example, if the legend is in the upper right comer, then the chart is updated to have the legend in the upper right comer. Business logic 210 executes and adjusts/modifies other aspects of the chart (e.g. size, etc.) as applicable to match the selected chart element variation (stage 240). If the application of any of the above settings fails, the system ignores and recovers from the error and continues with the next element variation (stage 242). For example, if the error occurs while creating a data table, then the entire data table will be removed from the chart and then the next element processed. The system does not leave an element that contains errors to be in an incomplete state on the chart. In the software art, this is referred to as an atomic transaction where all of the related tasks either succeed or fail together. Other variations of error recovery are also possible, such as to leave the chart in an incomplete state but to allow the user to make corrections. The process then ends at end point 244.

In one aspect of the invention, if a user clicks on an element variation, then entire action is placed on the undo stack. If the user clicks undo after selecting a variation, all elements are returned to their initial state before the variation was applied. Other variations for allowing a user to undo an element variation are also possible, such as returning only the most recent change to its initial state instead of the entire element variation.

In one aspect of the invention, a repeat feature is also supported. If a user clicks on an element variation with a chart selected, then selects another chart and selects a Repeat option, the element variation will be applied to the second chart. In one aspect of the invention, the user can re-add elements with previous custom formatting. If the user applied custom formatting on a chart element (e.g. picked a non-matching fill color for the legend) and then picked an element variation that removes the legend, the custom formatting of this chart element will not be retained. When the chart element is added back either through an element variation or through somewhere else in the user interface of chart application 200, it will have the default settings following the currently selected style for the chart.

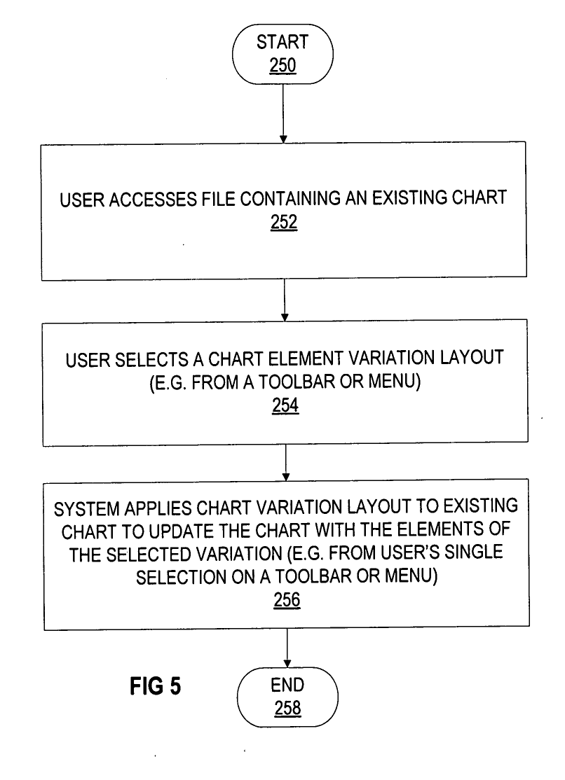

FIG. 5 illustrates the stages involved in updating an existing chart with a selected element variation layout. In one form, the process of FIG. 5 is at least partially implemented in the operating logic of system 100. The process begins at start point 250 with the user accessing files containing an existing chart (stage 252). The user selects a chart variation (e.g. from a toolbar or menu) (254). The system applies the chart variation to an existing chart to update the chart with the elements of the selected variation (e.g. from the user's single selection) (256). The process then ends at end point 258.

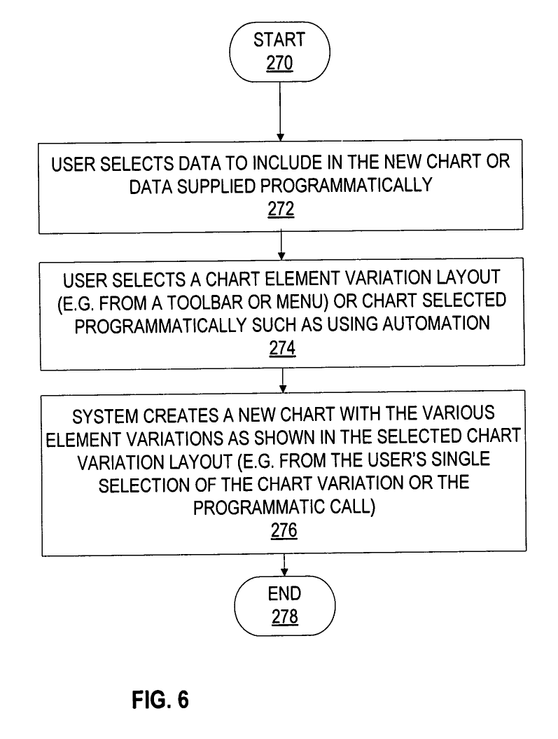

FIG. 6 illustrates the stages involved in creating a new chart by selecting a chart element variation layout. In one form, the process of FIG. 6 is at least partially implemented in the operating logic of system 100. The process begins at start point 270 with the user selecting data to include in a new chart, or the data being selected programmatically (stage 272). The user selects a chart variation layout (e.g. from a toolbar or menu), or the chart variation layout is selected programmatically (stage 274). The system creates a new chart with the various element variations as shown in the selected chart variation layout (e.g. from the user's single selection of the chart variation) (stage 276). In this example, the user applied a chart type to the chart by virtue of the chart variation selected, as opposed to first selecting a chart type and then selecting a chart variation that is available for that chart type. Either and/or both of these approaches are supported by chart application 200. The process then ends at end point 278.

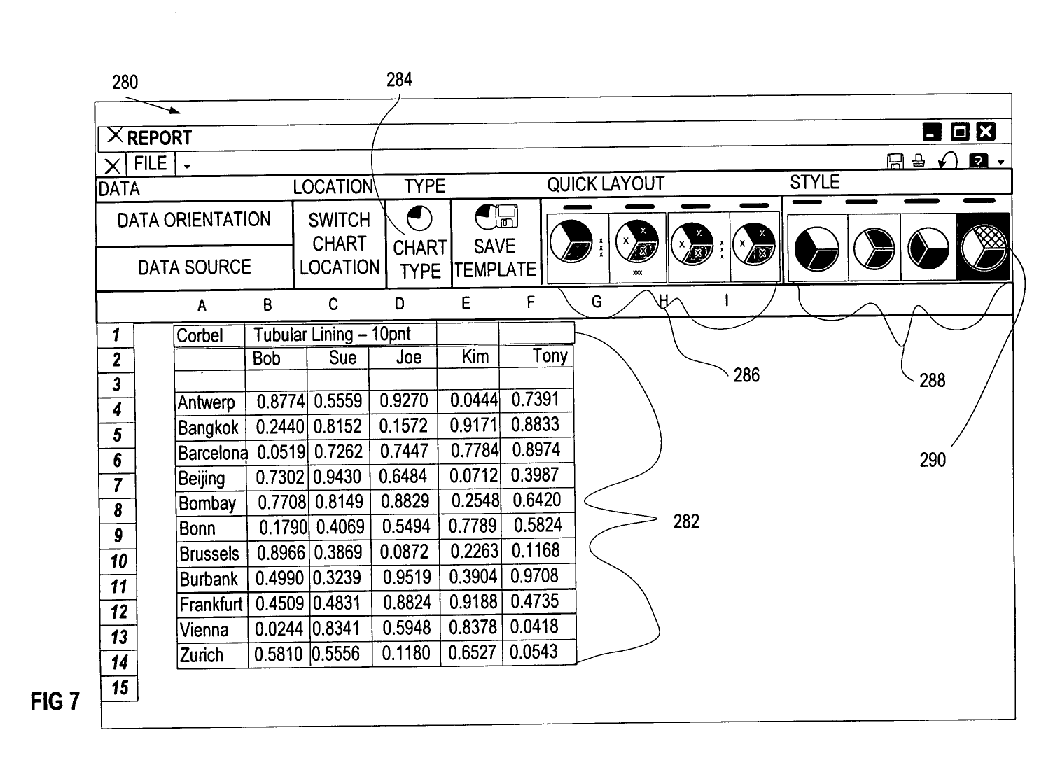

Turning now to FIGS. 7-10, a simulated screen and simulated charts will be used to illustrate some of the concepts described in FIGS. 3-6. FIG. 7 is a simulated screen 280 that illustrates how a user can select an element variation layout from a toolbar. The user can use screen 280 to select the data 282 to include in the chart. The user can also select a chart type using the chart type option 284. The user can also select one of the available element variation layouts 286, and/or one of the available chart styles 288 from toolbar 290. When the user selects one of the available element variation layouts 286, system 100 executes business logic 204 of chart application 200 to apply the selected element variations to the chart. Other variations are also possible for allowing the user to select element variation layouts and other options.

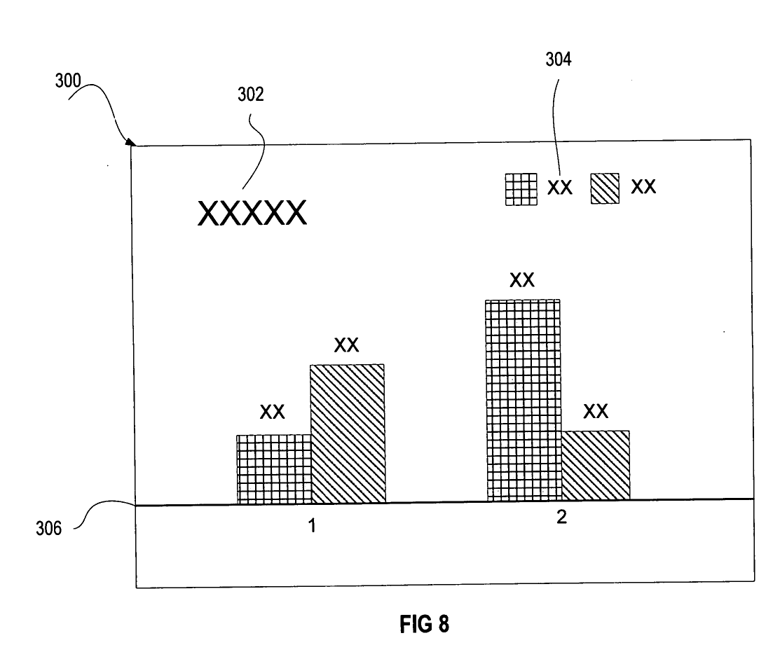

Turning now to FIGS. 8-12, simulated charts 300, 310, 320, 330, and 340 illustrate various chart element variation layouts that the user could apply to their chart, such as by selecting one of available element variation layouts 286 on FIG. 7. These simulated charts are illustrative in nature and are non-limiting examples. Fewer, additional, and/or different charts could also be used. Turning now to FIG. 8, simulated chart 300 has a layout that presents the actual data values in an elegant, yet simple way. The title 302 and legend 304 have been moved to the top corners to maximize the available space for the rest of the chart. The value (y) axis has been removed since the actual values, not the scale of the values, is more important. The category (x) axis 306 is simple as well and has no tick marks. A user might select chart 300 as the element variation layout for showing sales figures for the past few months in a presentation to the organization.

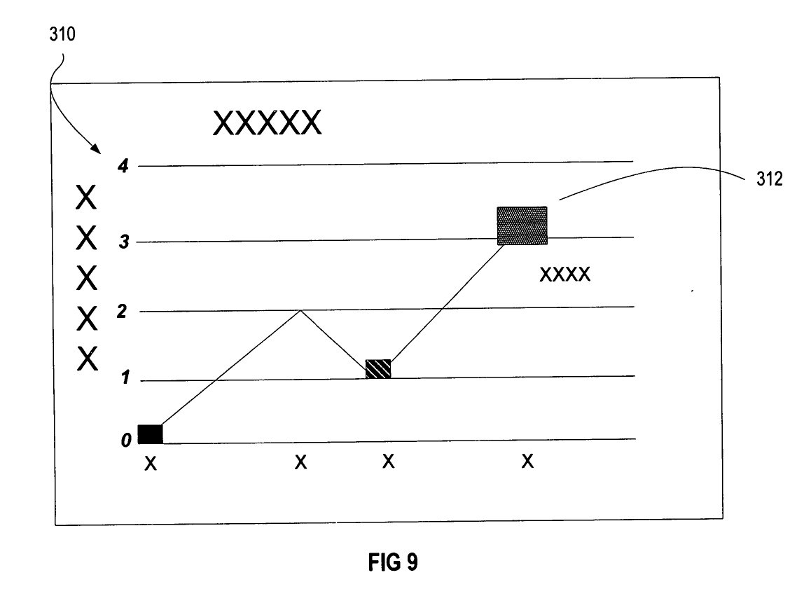

As shown on FIG. 9, simulated chart 310 has a layout that presents a line chart that points out the last data point in the series 312. In some systems prior to this invention, creating such a chart that points out the last data point involved various steps, such as deleting all but the last data point, selecting the last data point, selecting an option to make the data marker larger, getting a data label on the last point, etc. If the chart had twenty data points, you would have to click the delete key nineteen times to remove all data points but the last one that you wanted to keep.

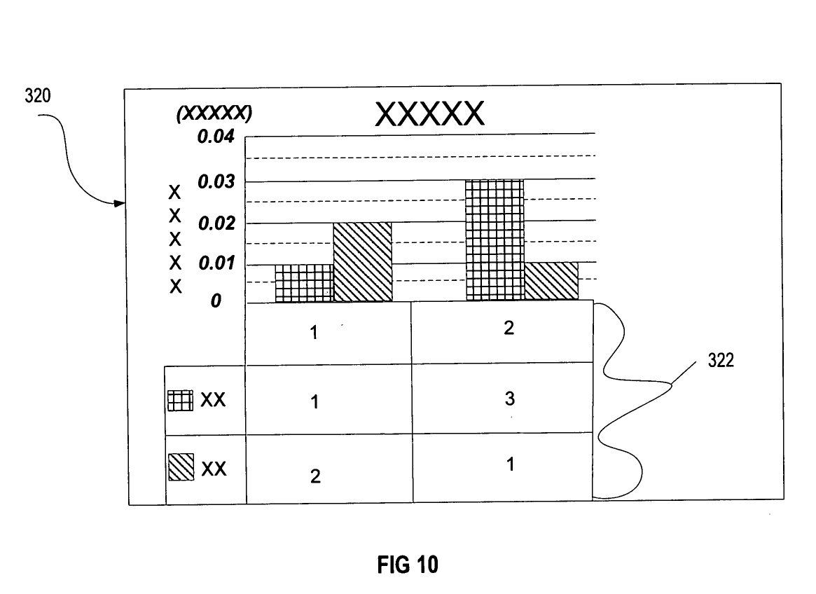

Turning now to FIG. 10, simulated chart 320 has a layout that focuses on the actual values. A data table 322 is used, but no data labels or legend are present. Once you have the data table, you typically don't need data labels or a legend, since all of the data is already nicely placed on the chart. One non-limiting example of when a user might use such a chart with a data table is to show sales figures for the past year for the 3 products their organization sells. In some systems prior to this invention, the user was able to easily turn on a lot of unnecessary elements. This resulted in a cluttered chart that was less meaningful, and required the user to make numerous deletions to get rid of extra elements if they wanted to make the chart simpler.

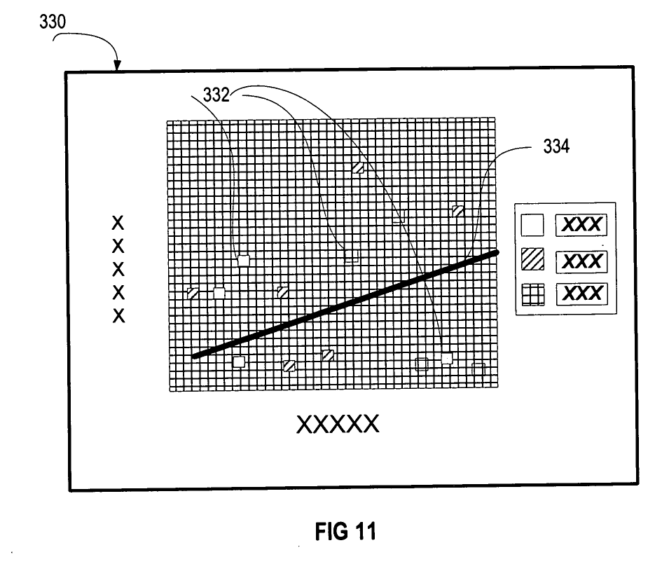

As shown on FIG. 11, simulated chart 330 has a layout for a scatter chart that is optimized for a large amount of data points 332. The unnecessary elements are turned off to maximize the space left for plotting the points. A trendline 334 is added to show what the trend of the data values are statistically.

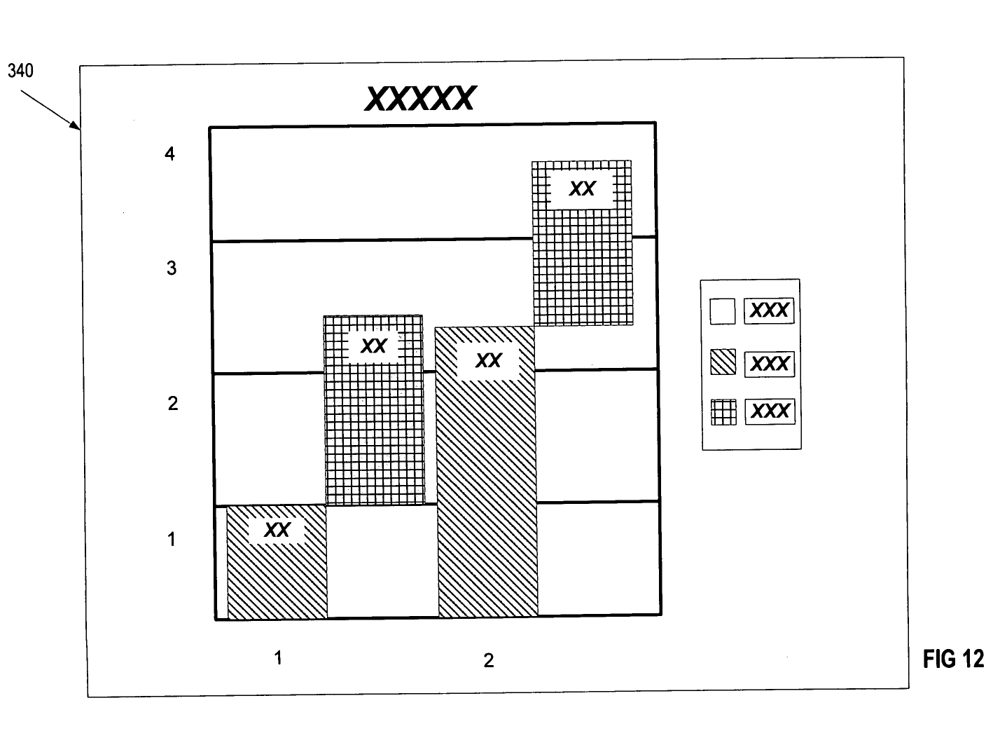

Turning now to FIG. 12, simulated chart 340 has a layout for a column chart that stacks the series, but does so in a way that the data value in each series is more visible, such as by offsetting each data point of a series to the right. In some systems prior to this invention, the user had to select an option to decrease the overlap setting for a series in order to apply this feature, and simply finding the option was difficult since it was buried at the end of the chart series dialog screens.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the inventions as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples and still be within the spirit of the invention.

What is claimed is:

1. A computer-readable medium having computer-executable instructions for causing a computer to perform steps comprising:
providing a plurality of chart element variation layouts for a user to select; receiving a request from a user to select a particular one of the chart element variation layouts; and
formatting a chart with a plurality of elements associated with the selected particular one of the chart element variation layouts.

2. The computer-readable medium of claim 1 further comprising the step of:
displaying the chart with the plurality of elements.

3. The computer-readable medium of claim 1, wherein the formatting the chart step further comprises:
removing existing elements from the chart that are not shown in the selected chart element variation layout;
adding elements to the chart that are shown in the selected chart element variation layout and are not already on the chart; and
leaving elements shown in the selected chart element variation layout that are already on the chart unchanged.

4. The computer-readable medium of claim 3 further comprising the steps of:
changing a location of elements that are based on a particular location to be in a same location as shown in the selected chart element variation layout.

5. The computer-readable medium of claim 3 further comprising the steps of:
ignoring and recovering from errors that occur when performing the formatting the chart step.

6. The computer-readable medium of claim 1 wherein the chart element variation layouts are operable to be selected by the user in a single operation.

7. The computer-readable medium of claim 1 wherein the chart element variation layouts are operable to be called programmatically from another program.

8. An apparatus for enhancing chart creation comprising:
means responsive to a request from a user for selecting a chart element variation layout with a single operation;
means for formatting a chart with a plurality of elements associated with the selected chart element variation layout; and
means for providing a display signal to a display such that the chart is displayed to the user after the chart has been formatted with the selected chart element variation layout.

9. A method for enhancing chart creation comprising the steps of:
receiving a selection from a user to select a particular one of a plurality of chart element variation layouts; and
performing a process to apply the selected chart element variation layout to a chart, the process of applying the selected chart element variation layout comprising:
removing existing elements from the chart that are not shown in the selected chart element variation layout;
adding elements to the chart that are shown in the selected chart element variation layout and are not already on the chart; and
leaving elements shown in the selected chart element variation layout that are already on the chart unchanged.

10. The method of claim 9, wherein the process of applying the selected chart element variation layout to the chart further comprises:
changing a location of elements that are based on a particular location to be in a same location as shown in the selected chart element variation layout.

11. The method of claim 9, wherein the process of applying the selected chart element variation layout to the chart further comprises:
ignoring and recovering from errors that occur.

12. The method of claim 9, wherein the chart element variation layouts are operable to be selected by the user in a single operation.

13. The method of claim 12, wherein the single operation is the selection of an area on a toolbar.

14. The method of claim 9, wherein the chart element variation layouts are operable to be called programmatically from another program.

15. The method of claim 9, further comprising:
displaying the chart to the user.

16. The method of claim 9, further comprising:
receiving a selection from a user for a particular chart style from a plurality of chart styles; and
applying the selected particular chart style to the chart.

17. The method of claim 9, wherein at least one of the chart element variation layouts is a line chart that points out a last data point in a series.

18. The method of claim 9, wherein at least one of the chart element variation layouts is a scatter chart that is optimized for a large amount of data points and has a trendline.

19. The method of claim 9, wherein at least one of the chart element variation layouts is a stacked column chart that stacks a plurality of series in a way that offsets each data point in each of the plurality of series to the right so that each data point is more visible.

20. A computer-readable medium having computer-executable instructions for causing a computer to perform the steps recited in claim 9.
